(19) United States
(12) Patent Application Publication
(10) Pub. No.: US 2026/0045722 A1
(43) Pub. Date: Feb. 12, 2026

(54) ELECTRICAL CONNECTORS AND SYSTEMS THEREOF INCLUDING PRE-BENT MALE PINS

(71) Applicant: J.S.T. Corporation, Farmington Hills, MI (US)

(72) Inventors: Ping CHEN, Novi, MI (US); Gwendolyn UPSON, Ypsilanti, MI (US); Eric BLANKINSHIP, Lathrup Village, MI (US)

(21) Appl. No.: 19/294,831

(22) Filed: Aug. 8, 2025

Related U.S. Application Data
(60) Provisional application No. 63/681,395, filed on Aug. 9, 2024.

(51) Int. Cl. H01R 13/04; H01R 12/70

(52) U.S. Cl. CPC H01R 13/04; H01R 12/707

(57) ABSTRACT

A pin assembly is provided. The pin assembly may include pre-bent pins that are formed during stamping and do not require further bending or plating before insertion into a housing. The pin assembly may include a first pin having a first leg, a first contact, a first transition portion engaging the first leg and the first contact, and a slot. The pin assembly may have a second pin having a second leg, a second contact, and a second transition portion engaging the second leg and the second contact. The slot may be configured to receive the second contact. The first transition portion may offset the first contact from the first leg in a first direction and the second transition portion may offset the second contact from the second leg in a second direction that opposes the first direction.

### CROSS REFERENCE TO RELATED APPLICATIONS

This application claims the benefit of U.S. Provisional Application No. 63/681,395, filed Aug. 9, 2024, which incorporated herein by reference in its entirety.

### FIELD

The present disclosure relates to connectors, particularly connectors having pre-bent male pins.

### BACKGROUND OF THE INVENTION

Electrical connectors can be used in various wiring systems. Electrical connectors can include a female housing and a male housing. The female housing can support one or more terminals for mating with one or more male pins supported by the male housing.

### BRIEF SUMMARY OF THE INVENTION

For surface-mount technology (SMT) connectors, typically, male pins are first inserted into the header and then further bent into a shape suitable for surface mounting during its assembly process. The male pins may mate with spring components positioned within a female terminal. According to some aspects of the present disclosure, the male pin instead is pre-formed during a stamping process so a male header assembly can receive the pin without further adjustment, such as bending. Advantageously, pre-forming the male pin in accordance with this disclosure increases precision relative to traditional installation methods and reduces the connector size. Because the pin of the present disclosure engages a male header assembly without requiring individuals to further manipulate the pin, the pin securely engages a connector having less space to manipulate the pin relative to other pin designs. As a result, the pre-bent pin of the present disclosure facilitates smaller connector sizes relative to other designs.

Further, according to some aspects, a rib extends below the contact. The rib provides an additional point of contact between a pin and the male housing, and therefore stabilizes the pin. As a result, the pin can be more accurately positioned within the header and coplanarity can be better controlled. Coplanarity is the tolerance for the gap between the contact points of the pins to the board relative to the contact points laying on a single uniform plane. On a PCB board, coplanarity facilitates uniform solder thickness between the board and each of the pins, which is desirable for performance as uniform.

In some aspects, the pin is bent 90-degrees. This facilitates an improved mating surface between the pin and its reciprocal mating component. For example, using a sheared face as a mating surface may produce undesirable electrical conductance due to burrs and an uneven surface associated with shearing, e.g., during stamping. By bending the pin 90-degrees, a smoother, more tightly controlled plated surface maximizes contact between the pin and its reciprocal mating surface, thereby improving electrical conductance relative to other designs.

In some aspects, the male pin is sized to accommodate a 90-degree bend. For example, when the pins are populated within the male housing, they may overlap one another from a rear view. In some instances, such as for high voltage applications, close proximity of pins may contribute to short-circuiting and arcing. Advantageously, the pins described herein may be sized to maximize the distance between pins while still presenting a smaller assembly than other pin designs.

### BRIEF DESCRIPTION OF THE DRAWINGS/FIGURES

The accompanying drawings, which are incorporated herein and form part of the specification, illustrate aspects of the disclosure and, together with the description, further serve to explain the disclosure and to enable a person skilled in the relevant art(s) to make and use the embodiments disclosed herein.

FIG. 1 is a perspective view of a set of pre-bent male pins according to aspects of the present disclosure;

FIG. 2 is a perspective view of the pre-bent male pins of FIG. 1;

FIG. 3 is an interior perspective view of FIG. 1;

FIG. 4 is a rear view of FIG. 1;

FIG. 5 is a perspective view of a pre-bent male pin of FIG. 1;

FIG. 6 is a side view of the pre-bent male pin of FIG. 5;

FIG. 7 is a rear view of the pre-bent male pin of FIG. 5;

FIG. 8 is a focused rear view of two adjacent pre-bent male pins of FIG. 1;

FIG. 9 is a perspective view of another pre-bent male pin of FIG. 1;

FIG. 10 is a side view of FIG. 9;

FIG. 11 is a rear view of FIG. 9;

FIG. 12 is a side cross-sectional view of FIG. 1 taken along 12-12 of FIG. 4;

FIG. 13 is a side cross-sectional view of FIG. 1 taken along 13-13 of FIG. 4;

FIG. 14 is a focused view of FIG. 2;

FIG. 15A is a perspective view of two pre-bent male pins of FIG. 1, with latches highlighted on the rib of each pin;

FIG. 15B is a perspective view of two-pre bent male pins of FIG. 1, with latches highlighted on the contacts of each pin;

FIG. 16A is a perspective view of a pre-bent male pin with latches according to aspects of the present disclosure;

FIG. 16B is a side view of the pre-bent male pin of FIG. 16A;

FIG. 16C is a rear view of the pre-bent male pin of FIG. 16A;

FIG. 17 is a perspective view of a pre-bent male pin with latches according to aspects of the present disclosure;

FIG. 18 is a perspective view of a set of pre-bent male pins according to aspects of the present disclosure;

FIG. 19 is a side view of a pre-bent male pin of FIG. 18;

FIG. 20 is a rear view of FIG. 19;

FIG. 21 is a side view of a pre-bent male pin of FIG. 18;

FIG. 22 is a rear view of FIG. 18;

FIG. 23 illustrates an exemplary sheet metal sheering process;

FIG. 24 is a perspective view of a set of pre-bent male pins in a male housing configured for a side entry connector according to aspects of the present disclosure;

FIG. 25 is a rear view of FIG. 24;

FIG. 26 is a perspective view of a set of pre-bent male pins in a male housing configured for a top entry connector according to aspects of the present disclosure;

FIG. 27 is a top view of FIG. 26;

FIG. 28 is cross-sectional perspective view of FIG. 26;

FIG. 29 is a rear view of a set of pre-bent male pins according to aspects of the present disclosure.

### DETAILED DESCRIPTION OF THE INVENTION

The present invention(s) will now be described in detail with reference to aspects thereof as illustrated in the accompanying drawings. References to “one aspect,” “an aspect,” “an exemplary aspect,” etc., indicate that the aspect described may include a particular feature, structure, or characteristic, but every aspect may not necessarily include the particular feature, structure, or characteristic. Moreover, such phrases are not necessarily referring to the same aspect. Further, when a particular feature, structure, or characteristic is described in connection with an aspect, it is submitted that it is within the knowledge of one skilled in the art to affect such feature, structure, or characteristic in connection with other aspects whether or not explicitly described.

The following examples are illustrative, but not limiting, of the present aspects. Other suitable modifications and adaptations of the variety of conditions and parameters normally encountered in the field, and which would be apparent to those skilled in the art, are within the spirit and scope of the disclosure.

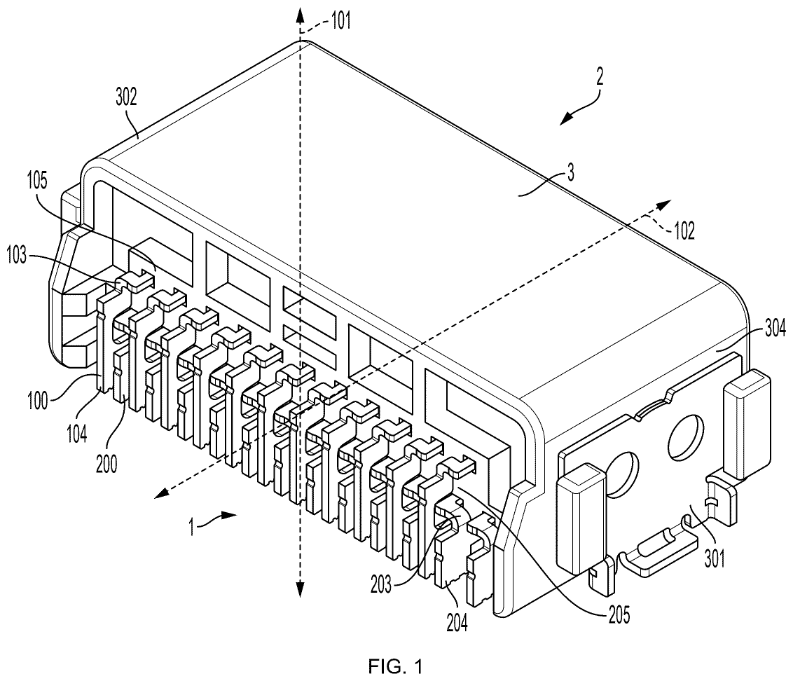

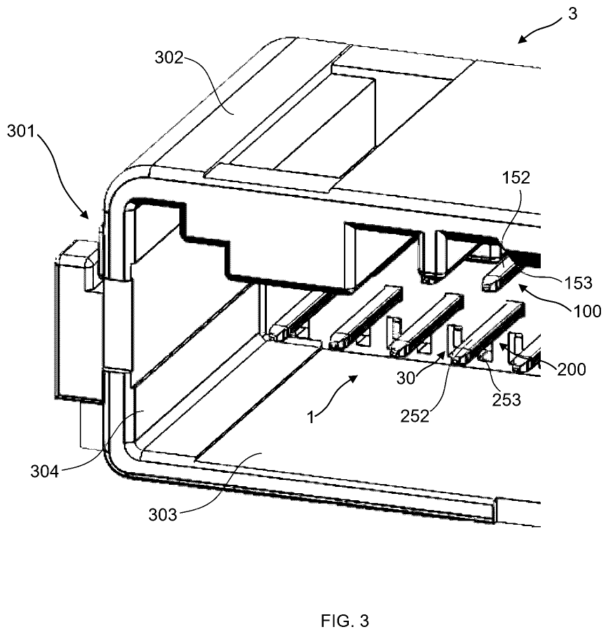

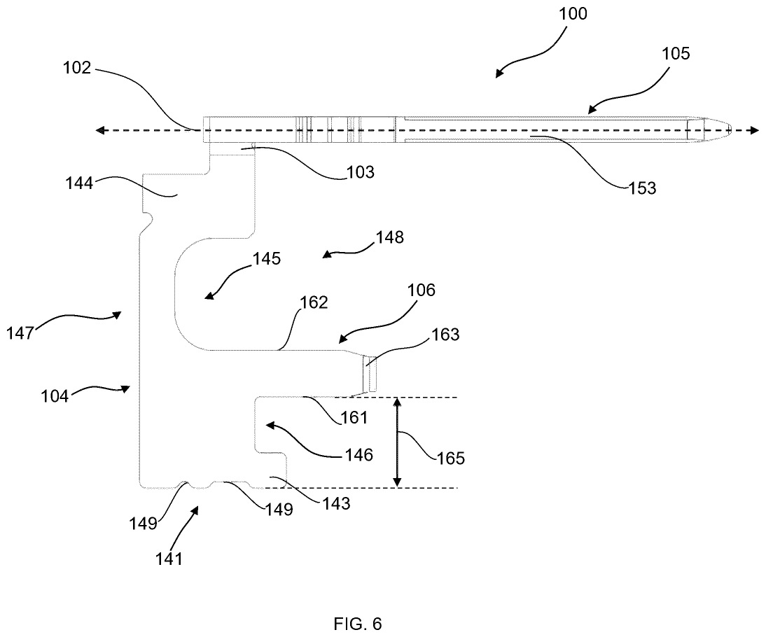

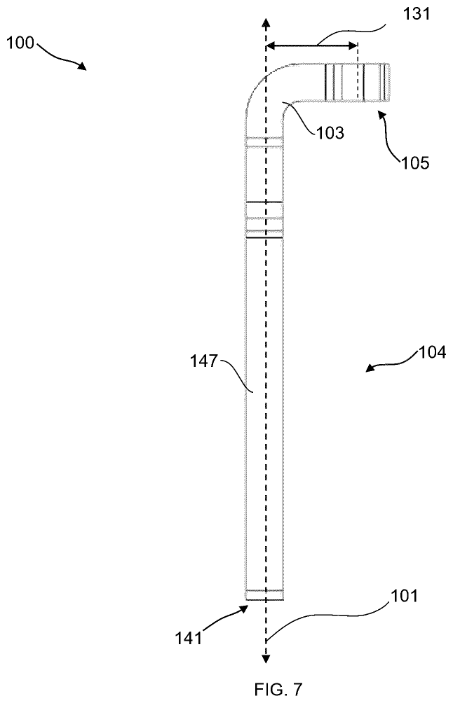

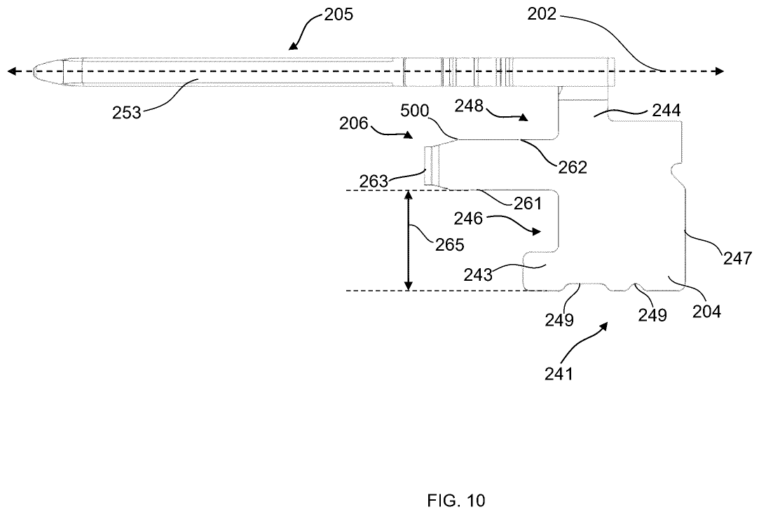

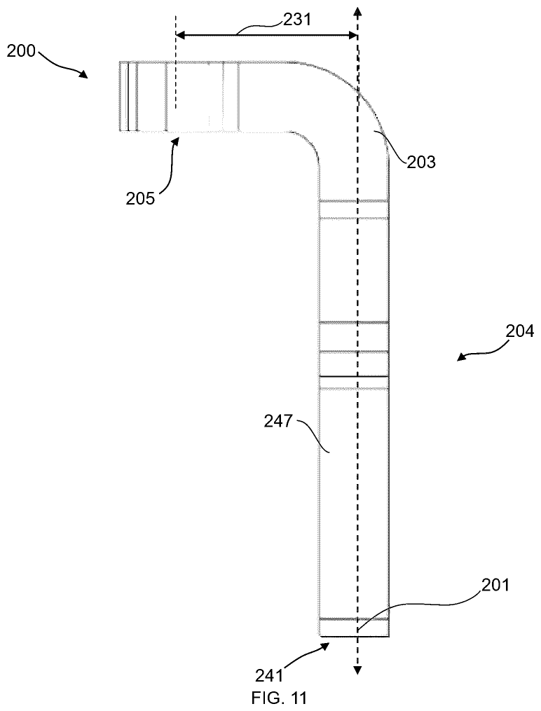

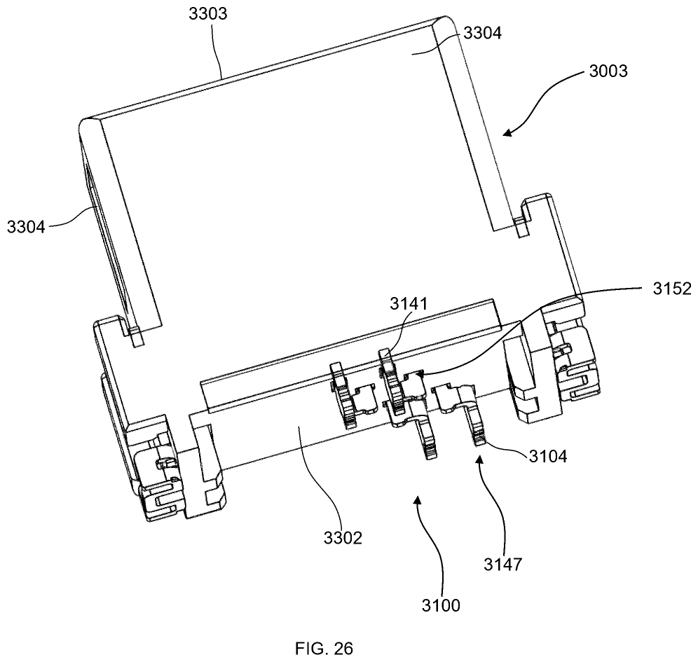

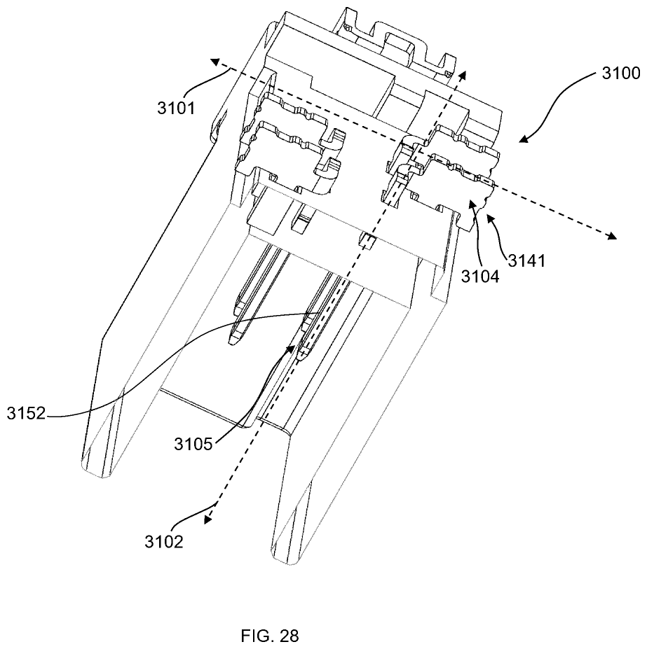

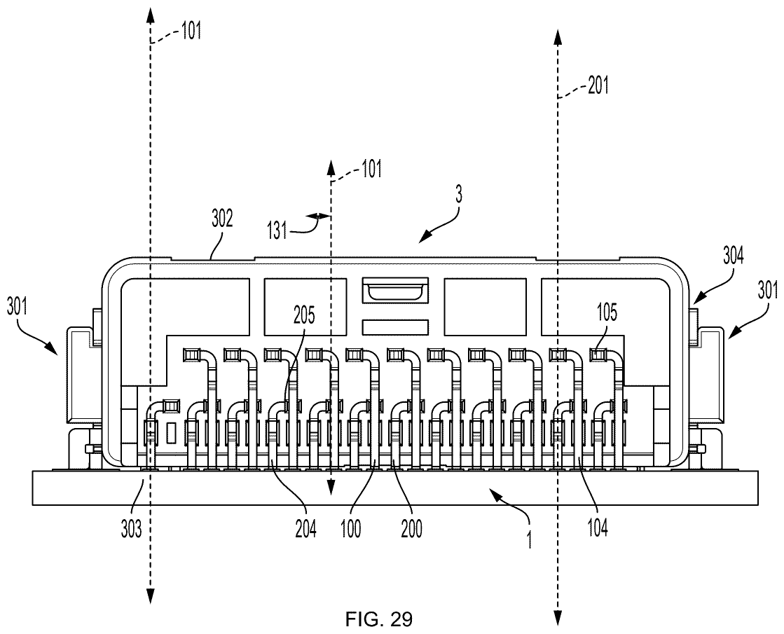

Turning now to FIGS. 1-11, a male pin assembly 1 is shown that is received within a male housing 3 to form a male connector 2. In some aspects, male pin assembly 1 includes a first pin 100 and a second pin 200. Male housing 3 may include a top surface 302 and a bottom surface 303. Further, reinforcement tabs 301 engage male housing 3 in some aspects. In some aspects, pins 100, 200 include a leg 104, 204 and a contact 105, 205 extending generally orthogonally to, and offset from, leg 104, 204. When received in male housing 3, leg 104 of pin 100 and leg 204 of pin 200 can extend to the same height and are aligned. Contacts 105, 205 include a mating surface 152, 252 configured to engage a reciprocal mating surface within the connector, such as a spring. When received in male housing 3, contact 105 of pin 100 can extend higher than contact 205 of pin 200. In some aspects, pins 100, 200 further include a side bend that orients mating surface 152, 252 generally parallel with top surface 302. As discussed in more detail below, and referencing FIGS. 26-28, pins 3100 can be configured for top entry, and in such as a configuration, the side bend orients a mating surface 3152 generally orthogonal with a top surface 3302. A transition portion 103, 203 may define the side bend as a 90-degree rotation of the contacts 105, 205 from a vertical axis 101, 201 extending between the top surface 302 of the housing 3 and the bottom surface 303 of the housing 3. The side bend may rotate contact 105, 205 about a rotation axis 109, 209 that is generally orthogonal to vertical axis 101, 201, generally coplanar with a top 142, 242 of leg 104, 204 and offset in the direction of the side bend. The side bend facilitates a smaller connector size and, in some aspects, orients mating surfaces 152, 252 to engage a reciprocal mating surface without requiring additionally processing, such as bending the pin or re-plating after stamping. As a result, the pins 100, 200 of the present disclosure facilitate a compact connector and superior conductivity relative to other designs. In some aspects, as shown in FIG. 28, the side bend offsets contact 105, 205 from leg 104, 204 in an opposing direction relative to the side bend illustrated in FIGS. 1-11.

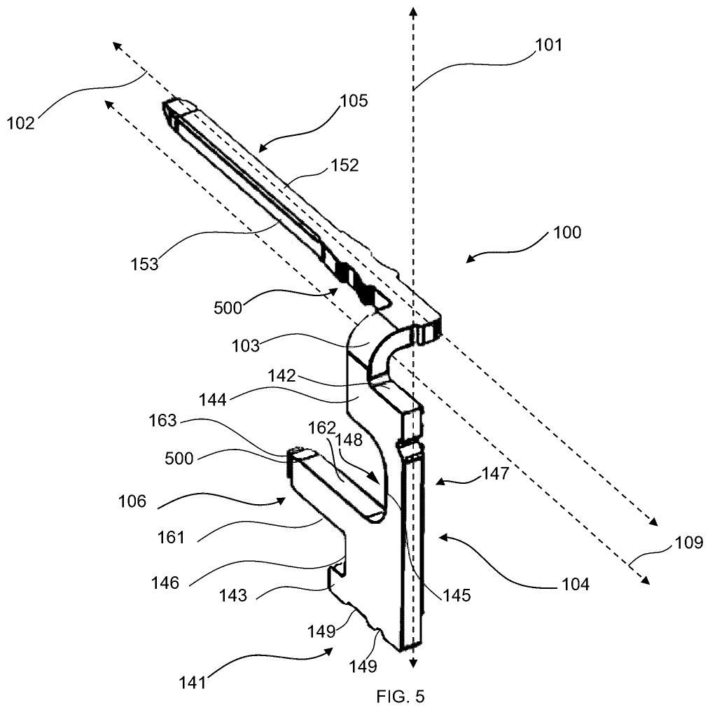

The complementary structures of pins 100, 200, such as the opposing side bend applied to pins 100, 200 described below minimize the connector size and provide a finished mating surface without increasing processing time. FIGS. 5-7 illustrate a first pin 100 having a leg 104 and a contact 105. In some aspects, leg 104 includes a base 141 having one or more indents 149. Indent 149 presents extra surface area for soldering relative to a flat surface, and therefore improves solder contact between pin 100 and a PCB board. In some aspects, first pin 100 further includes a vertical axis 101 extending generally orthogonally to base 141 and through leg 104, so that when pin 100 is inside male housing 3, vertical axis 101 extends between a top surface 302 and a bottom surface 303 of male housing 3, and generally parallel to side walls 304. First pin 100 also comprises a longitudinal axis 102 extending generally orthogonally to vertical axis 101 and through contact 105, so the longitudinal axis extends generally parallel to top surface 302, bottom surface 303, and side walls 304 of housing 3 when pin 100 is inside male housing 3.

In some aspects, first pin 100 also includes a transition portion 103 extending between leg 104 and contact 105 that defines a side bend consistent with the orthogonal relationship between the vertical axis 101 and longitudinal axis 102. Transition portion 103 can be curved, as shown in FIGS. 5-7, or can be generally cornered. Accordingly, pin 100 includes an offset 131 between contact 105, or longitudinal axis 102, and leg 103, or vertical axis 101, where offset 131 extends between vertical axis 101 and longitudinal axis 102 in a direction generally parallel with longitudinal axis 102 and generally perpendicular to vertical axis 101. In some aspects, offset 131 is between 0.5 mm to 1.5 mm, such as 1.05 mm. By defining a side bend, transition portion 103 flips contact 105 relative to leg 104 to align mating surface 152 with a reciprocal mating surface, such as a spring in a female housing. As a result, pre-bent pin 100 can enter a female housing without requiring subsequent processing, including bending or re-plating, after stamping.

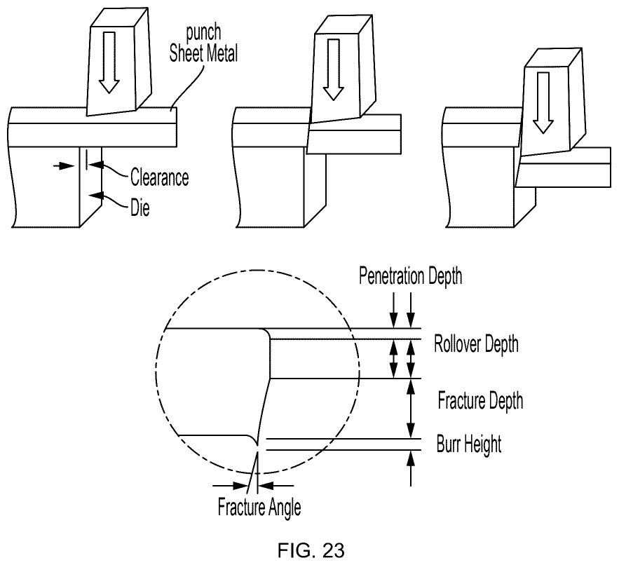

Specifically, contact 105 includes mating surface 152 and sheared surface 153. Sheared surface 153 can form during stamping and can present a non-uniform surface including, for example, burrs, as shown in FIG. 23. After stamping, the sheet metal has a sheared surface with distinct portions associated with a penetration depth, rollover depth, fracture depth, and potential burr height. When a punch engages sheet metal it pierces the metal at a penetration depth and defines a rollover depth as it begins pulling the metal down. The downward stress on the metal increases until it fractures. Accordingly, the metal develops a fracture depth and potentially a burr having a burr height. The fracture depth and burr height represent surfaces with distinct heights and angles relative to the remainder of the metal part and as a result, the sheared surface may be generally rougher than a finished surface not contacted or not adversely affected by the stamping process.

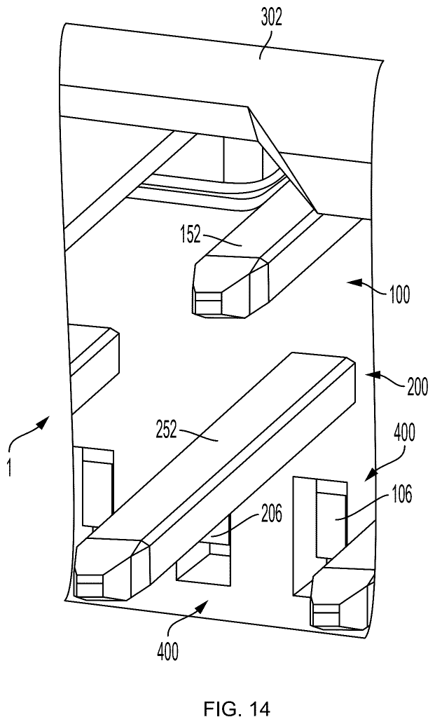

A relatively rough sheared surface 153 is undesirable for electrical conductance. Specifically, rougher surfaces may reduce the contact points between components relative to a smoother surface. Restricted contact between components impedes the flow of electricity and therefore reduces efficiency. Mating surface 152, by contrast, is smoother than sheared surface 153. A smooth surface provides greater contact area between components relative to a rough surface and therefore improves electrical conductance. Although a sheared surface can be configured to be a mating surface by, for example, plating to cover the roughness of the sheared surface, the plating step adds time and complexity to the manufacturing process and still degrades electrical conductivity because of the roughness of the underlying sheared surface. As shown in FIG. 5 and FIG. 14, mating surface 152 extends generally parallel to longitudinal axis 102 and may be generally orthogonal to sheared surface 153. Pin 100 is pre-bent, such that the stamping process produces the generally parallel relationship between mating surface 152 and longitudinal axis 102 so mating surface 152 aligns with a reciprocal mating surface without requiring bending or re-plating after stamping. Therefore, pre-bent male pin 100 can supply superior conductance between components without increasing production time.

Leg 104 further includes an outer surface 147 and an inner surface 148. Leg 104 also has a lower extension 143 and an upper extension 144 forming part of inner surface 148. In some aspects, lower extension 143 and upper extension 144 extend generally parallel to longitudinal axis 102. In further aspects, leg inner surface 148 includes a slot 145 between contact 105 and leg 104. As discussed in more detail below, in some aspects, slot 145 is disposed between a rib 106 and contact 105, and leg 104 further comprises a port 146 disposed between rib 106 and base 141. Also, rib 106 can engage a recess 30 in male housing 3 providing contact surfaces between pin 100 and male housing 3 to help stabilize pin 100.

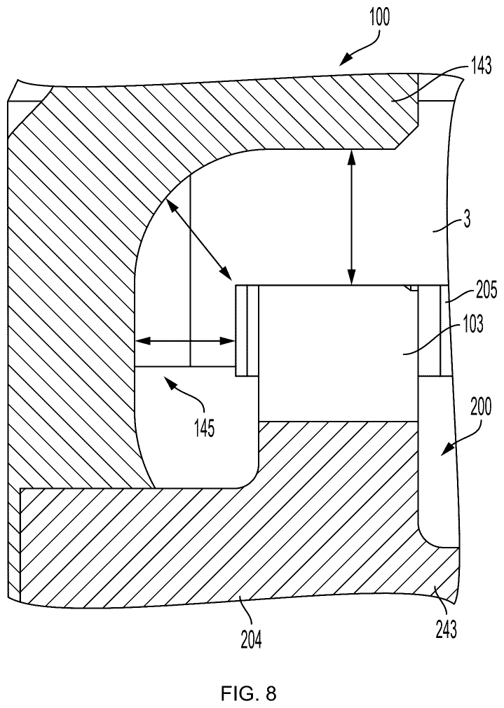

As shown in FIG. 8, slot 145 can be configured to receive a contact 205 of a second pin 200 when pin assembly 1 is inside male housing 3. Specifically, slot 145 provides space below contact 105 for contact 205 to extend. As a result, contacts 105, 205 overlay each other inside male housing 3, reducing the size of pin assembly 1.

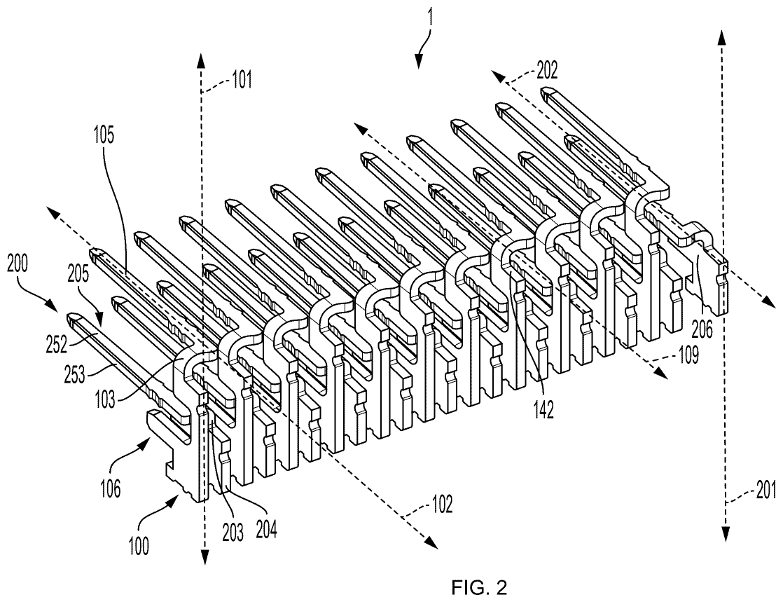

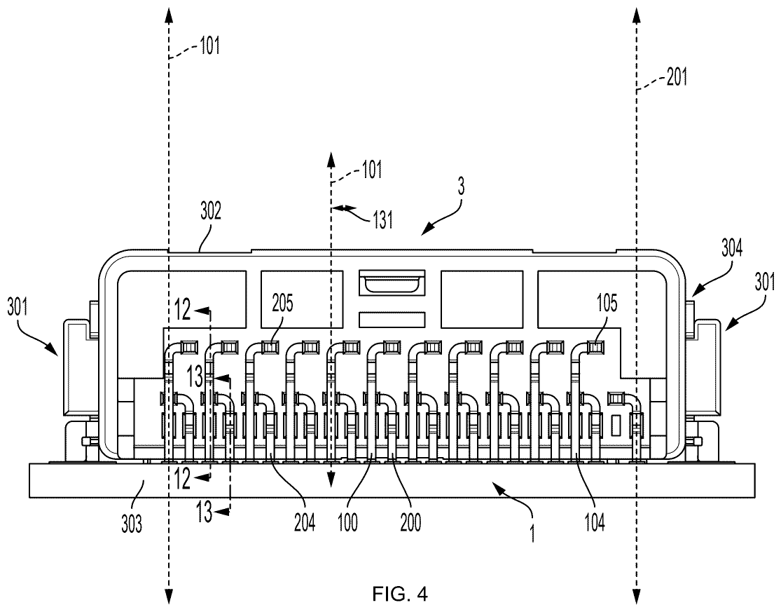

For example, slot 145 can include discrete curved portions that provide sufficient spacing between contact 105 of first pin 100 and contact 205 of second pin 200. As a result, pin assembly 1 can have a dual row configuration, as shown in FIG. 4, where contact 105 overlays contact 205 as shown in FIG. 2. The dual row configuration shown in FIG. 4 reduces the connector size while mitigating potential short circuiting or arcing because slot 145 provides sufficient separation between contacts 105, 205. Slot 145 can be curved, rectangular, triangular, or any other shape suitable to receive contact 205 of second pin 200 so that contacts 105, 205 can safely overlay each other.

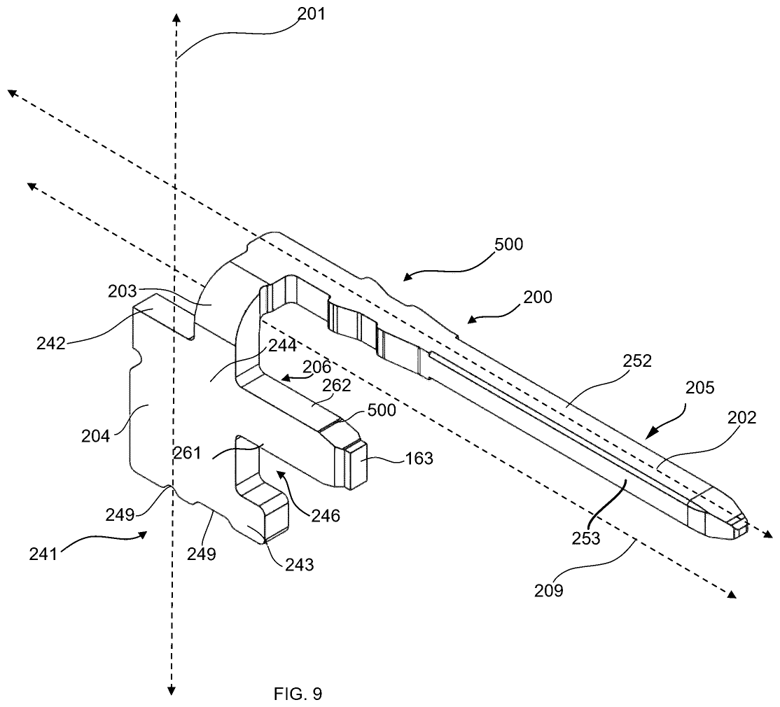

As shown in FIGS. 9-11, second pin 200 is also a pre-bent pin to present a finished mating surface 252 without requiring re-plating or bending after stamping. Specifically, second pin 200 may include a leg 204, and a contact 205. Like first pin 100, second pin 200 includes a vertical axis 201 extending orthogonally to a base 241 and through leg 204, so vertical axis 201 extends between top surface 302 and bottom surface 303, and generally parallel to side walls 304. Second pin 200 also includes a longitudinal axis 202 extending generally orthogonally to vertical axis 201 and through contact 205, so longitudinal axis 202 extends generally parallel to top surface 302, bottom surface 303, and side walls 304.

Also like first pin 100, second pin 200 includes a transition portion 203 between leg 204 and contact 205 that defines a side bend consistent with the orthogonal relationship between vertical axis 201 and longitudinal axis 202. Accordingly, pin 200 includes an offset 231 between contact 205, or longitudinal axis 202, and leg 204, or vertical axis 201, where offset 231 extends from vertical axis 201 to longitudinal axis 202 in a direction generally parallel with longitudinal axis 202 and generally perpendicular to vertical axis 201. By defining a side bend, transition portion 203 aligns mating surface 252 with a reciprocal mating surface inside a female housing, such a spring contact, without requiring subsequent processing, such as bending or re-plating, after stamping.

Specifically, like first pin 100, contact 205 includes a mating surface 252 and a sheared surface 253 in some aspects. In some aspects, mating surface 252 extends generally parallel to longitudinal axis 202 and sheared surface 253 extends generally orthogonally to longitudinal axis 202. The stamping process can produce the generally parallel relationship between mating surface 252 and longitudinal axis 202 so mating surface 252 can engage a reciprocal mating surface inside the connector without requiring bending or re-plating after stamping. Therefore, as discussed above relative to pre-bent male pin 100, pre-bent male pin 200 can supply superior conductance between components while reducing production time.

As shown in FIG. 2, transition portion 203 of second pin 200 can offset contact 204 in an opposing direction relative to offset 131 of first pin 100. As a result, mating surface 152 of first pin 100 overlays mating surface 252 of second pin 200 to provide a dual row configuration, as shown in FIG. 4, which minimizes the footprint of pins 100, 200 in the connector.

Like first pin 100, leg 204 of second pin 200 includes an outer surface 247 and an inner surface 248. In some aspects, leg 204 further comprises an extension 243 and a rib 206 extending from inner surface 248. Extension 243 and rib 206 extend generally parallel to longitudinal axis 102. Further, in some aspects, leg inner surface 248 includes a port 246 between extension 143 and rib 206.

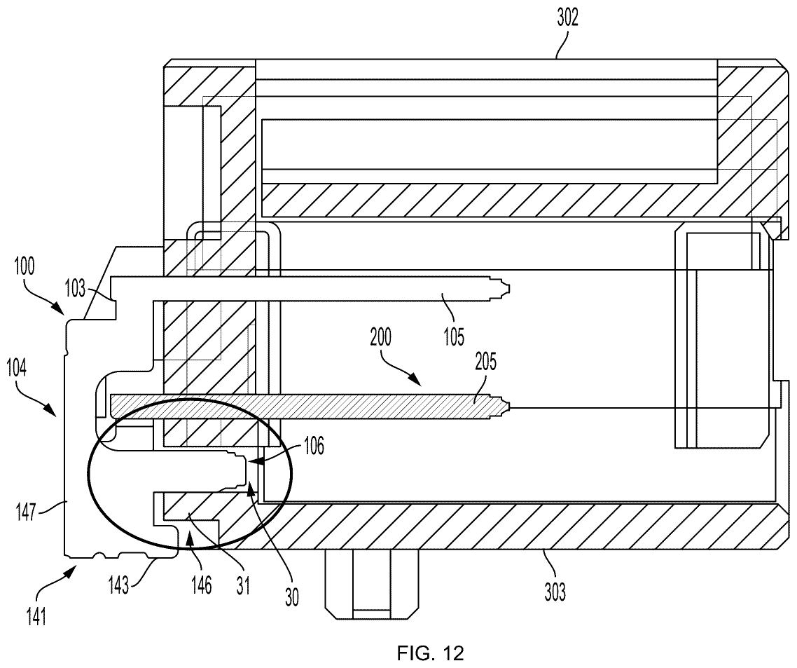

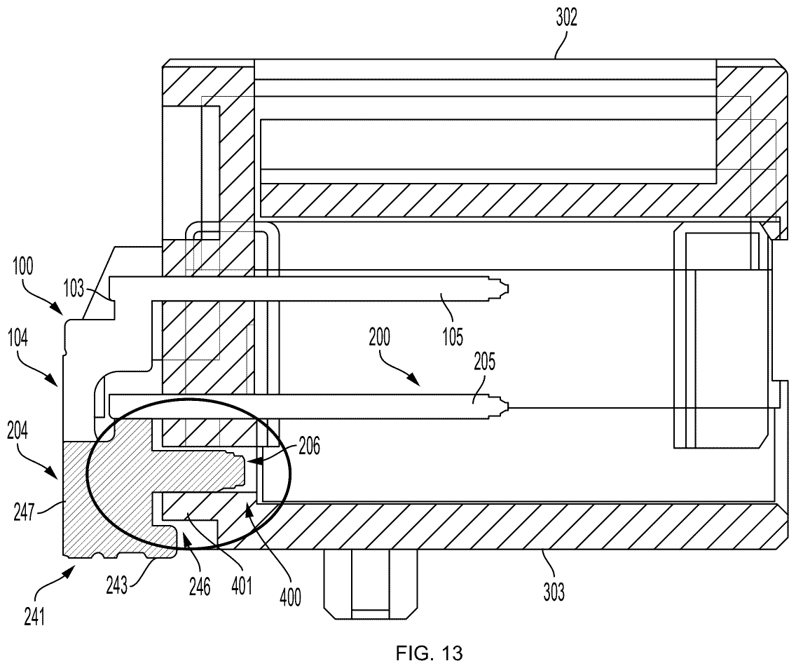

As shown in FIGS. 12-13, pins 100, 200 include ribs 106, 206 extending from legs 104, 204. Ribs 106, 206 can be integral with legs 104, 204 or can be separate components that can be, for example, detachably coupled. For example, ribs 106, 206 can be formed at the same time as, and from the same material as, the remainder of pin 100, 200 during stamping. Alternatively, ribs 100, 200 can be separately formed to have unique material properties relative to the remainder of pins 100, 200. In some aspects it can be desirable for ribs 106, 206 to have distinct material properties, such as stiffness, to help stabilize and position ribs 106, 206 in male housing 3. Alternatively, it can be desirable for ribs 106, 206 to be integrally formed with pin 100, 200 to reduce the number of parts and assembly time. Ribs 106, 206 can engage recesses 30 in male housing 3 to help secure and stabilize pins 1 within housing 3. As discussed in more detail below, in some aspects, ribs 100, 200 include protrusions to provide additional contact surface area between ribs 100, 200 and male housing 3, which further help secure and stabilize pins 1 in male housing 3.

Ribs 106, 206 also have a height 165, 265 that can dictate the coplanarity on the board-side of the pins 100, 200. For example, while traditional surface mounting methods require individuals to place pins flush with the board, the present disclosure allows individuals to adjust the spacing between pins and a board, thereby adjusting board-side coplanarity, by modifying rib height 165, 265 and the corresponding position of recesses 30. Non-uniform spacing between pins 100, 200 and a board can introduce uneven power distribution across pin assembly 1. For example, if the same amount of solder is applied to each pin, some pins may not have sufficient solder, or may have too much. By modifying rib height 165, 265, individuals can better ensure that the spacing between pins 100, 200 and a board is uniform across pin assembly 1 and within tolerances. Therefore, a connector having pins 100, 200 can have tighter tolerances on the spacing between pins 100, 200 and a board, and thus more consistent solder thickness between the pins and the board to provide uniform performance across pin assembly 1.

In some aspects, pin 100 may include rib 106 extending between, and generally parallel to, upper extension 143 and lower extension 144, defining slot 145 and port 146. In further aspects, rib 106 includes a lower surface 161, an upper surface 162, and a tip 163. Housing 3 walls defining recesses 30 can surround rib 106.

Slot 145 can be between upper surface 162 of rib 106 and contact 105 and can receive contact 205 of second pin 200 so contact 105 overlays contact 205 inside male housing 3. In some aspects, slot 145 is disposed between upper surface 162 of rib 106 and upper extension 144. Rib 206 of second pin 200 may similarly communicate with a recess 30. Specifically, rib 206 can also include a lower surface 261, an upper surface 262, and a tip 26, and recess 30 walls can surround rib 206.

In some aspects, leg 104, 204 also includes a port 146, 246 between lower surfaces 161, 261 of ribs 106, 206 and bases 141, 241, configured to engage an overhang 31 of housing 3. In some aspects, such as in FIGS. 12-13, ports 146, 246 partially define inner surfaces 148, 248 of legs 104, 204 between ribs 106, 206 and lower extensions 143, 243. The communication between overhang 31 and ports 146, 246 can further help stabilize and position pin 100, 200 by providing contact surfaces between pins 100, 200 and housing 3. Ports 146, 246 can be curved, rectangular, triangular, or can have any other cross section suitable to receive overhang 31 of housing 3.

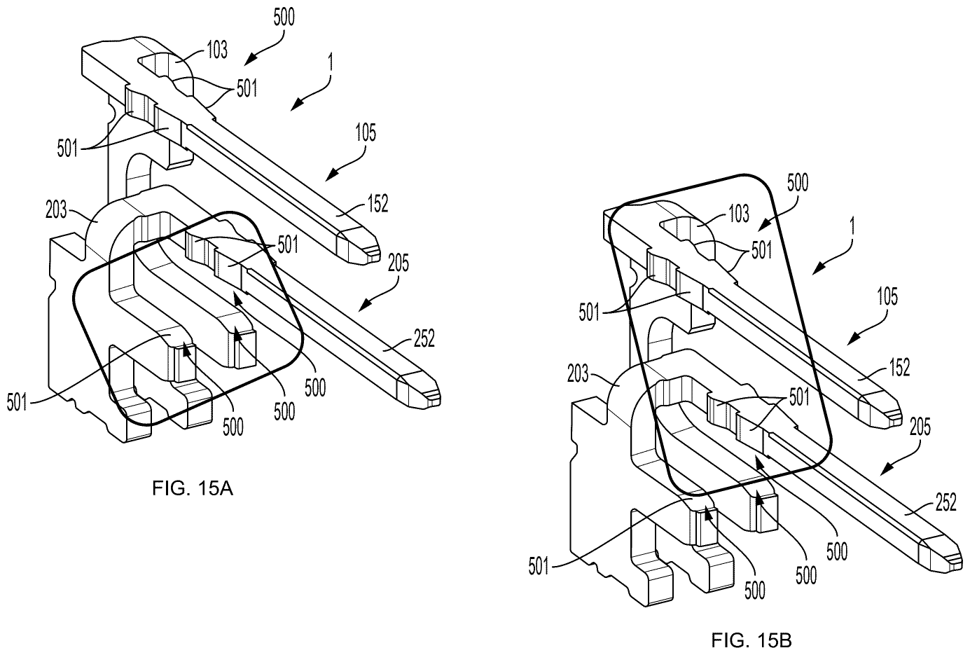

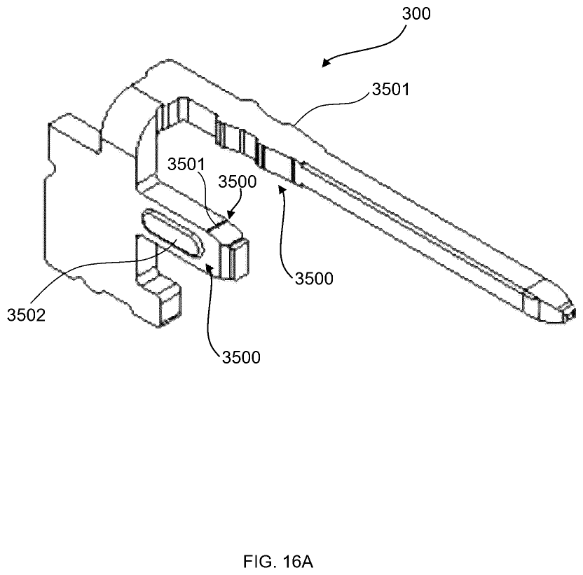

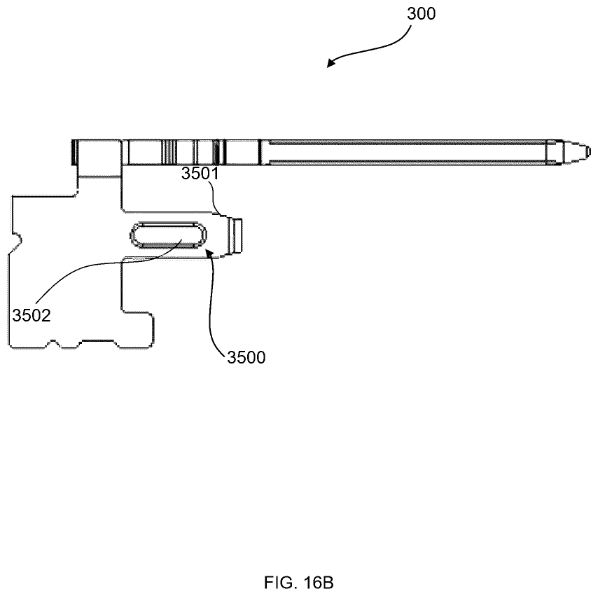

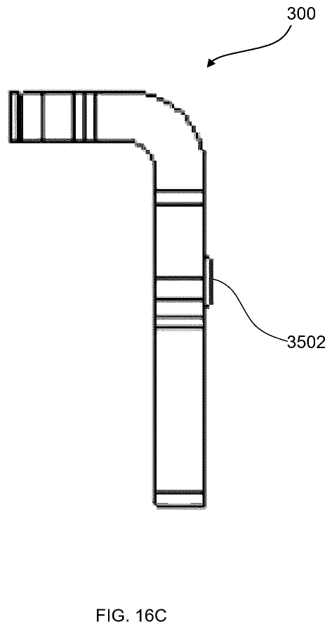

In some aspects, pins 100, 200 further include latches 500 protruding from ribs 106, 206 or contacts 105, 205, as shown in FIGS. 15A and 15B. Latches 500 can be configured to engage housing 3 and further help secure and stabilize pins 100, 200 by interlocking with complementary cutouts in male housing 3, thereby increasing the resistance of pin 100, 200 to detachment from male housing 3. Latches 500 can include a protrusion 501 extending away from contacts 105, 205 or ribs 106, 206. In some aspects, latches 500 include multiple sloped protrusions 501, as shown on contacts 105, 205 in FIGS. 15A and 15B. Further, some aspects include multiple latches 500 on contacts 105, 205, and a single latch 500 on ribs 106, 206, or vice versa. Latches 500 can have a triangular, circular, rectangular, or any other cross-section suitable to secure pins 100, 200 in male housing 3. In some aspects, a pin 300 has latches 3500 including a raised protrusion 3502 that has a generally oval shape, as shown in FIGS. 16A-16C. In further aspects, raised protrusion 3502 has a generally flat, raised surface that is rectangular, square, trapezoidal, circular, or any other cross section suitable to secure pins 100, 200 in male housing 3. In additional aspects, raised protrusion 3502 has a variable thickness. For example, in some aspects, raised protrusion 3502 is sloped and has a shape similar to latch 500.

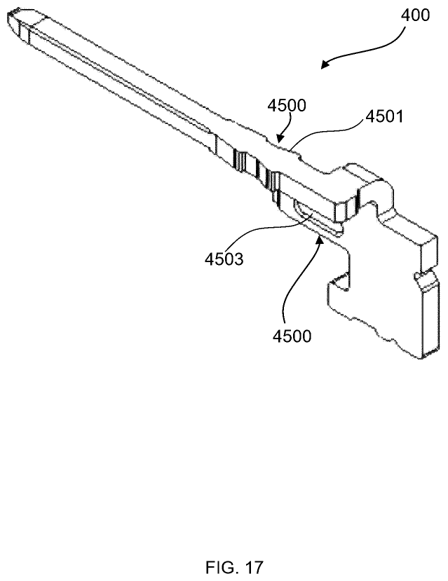

In some aspects, as shown in FIG. 16A, latches 3500 include raised protrusion 3502 and or more sloped protrusions 3501. In further aspects, as shown in FIG. 17, a pin 400 has latches 4500 including a latch slot 4503 configured to receive a corresponding protrusion in male housing 3. Although FIG. 17 shows latch slot 4503 as generally oval, latch slot 4503 can be rectangular, square, trapezoidal, circular, or any other cross section suitable to secure pins 400 in male housing 3. In some aspects, as shown in FIG. 17, pin 400 includes a combination of latches 4500 including latch slot 4503 and sloped protrusions 4501. The pins 100, 200, 300, 400 disclosed herein can have substantially similar features, and the features illustrated with respect to each pin can be combined without departing from the scope of this disclosure.

Combining latch 500 configurations, as discussed above, provides localized support for ribs 100, 200 within male housing 3. For example, in some aspects, pins 100, 200, have a raised protrusion 3502 configured to extend from a side surface of ribs 106, 206 and one or more sloped protrusions 501 extending from a top surface of ribs 106, 206. Raised protrusion 3502 provides vertical support to position pins 100, 200 in male housing 3. Sloped protrusions 501 extending upward from ribs 106, 206 resist horizontal movement of pins 100, 200 when inside male housing 3, and can be efficiently configured (e.g., less material) because raised protrusion 3502 extending sideways relative to ribs 106, 206 provides vertical support for pins 100, 200 within male housing 3.

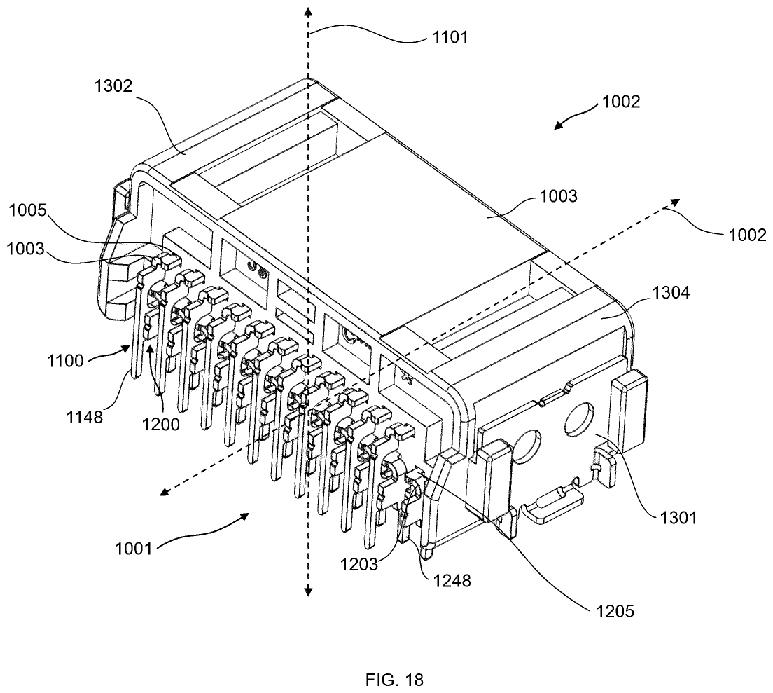

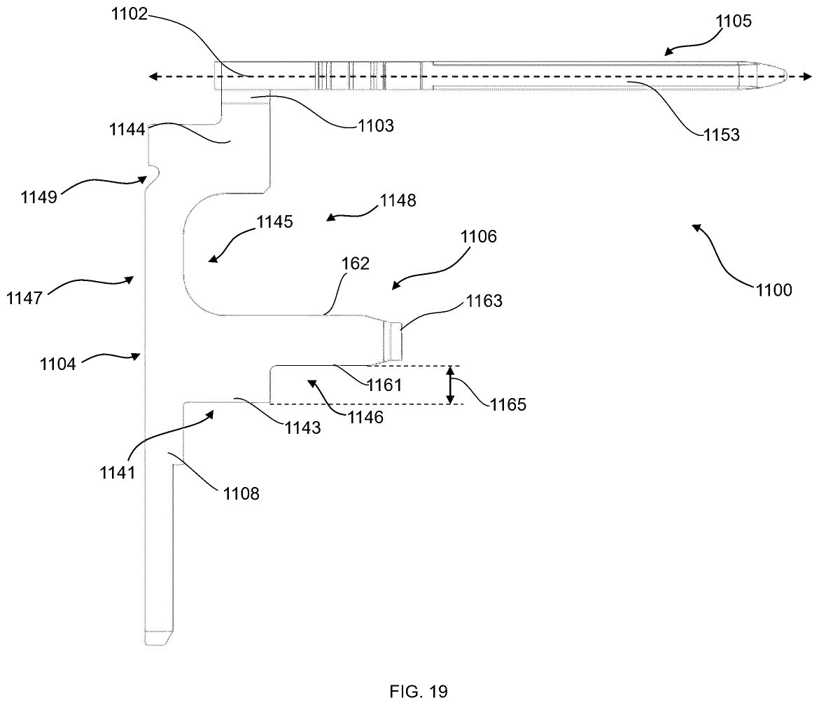

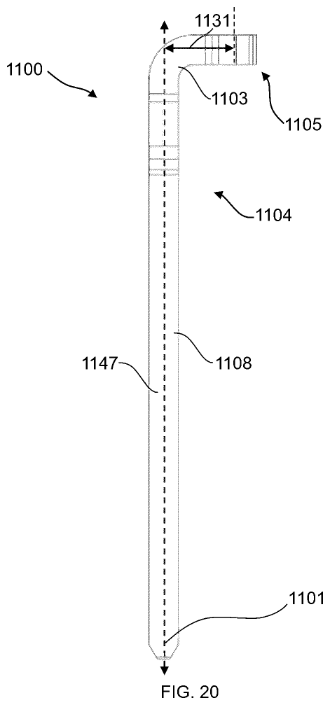

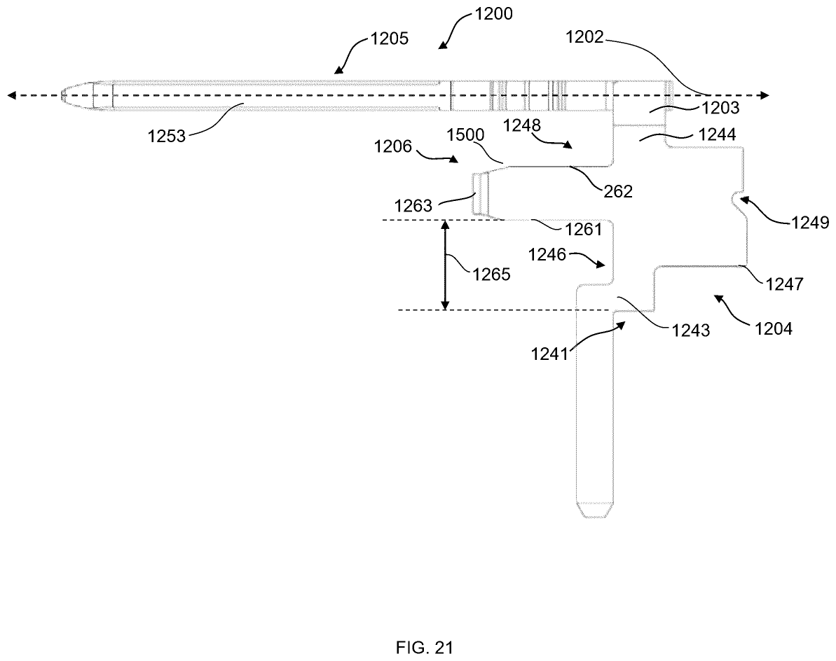

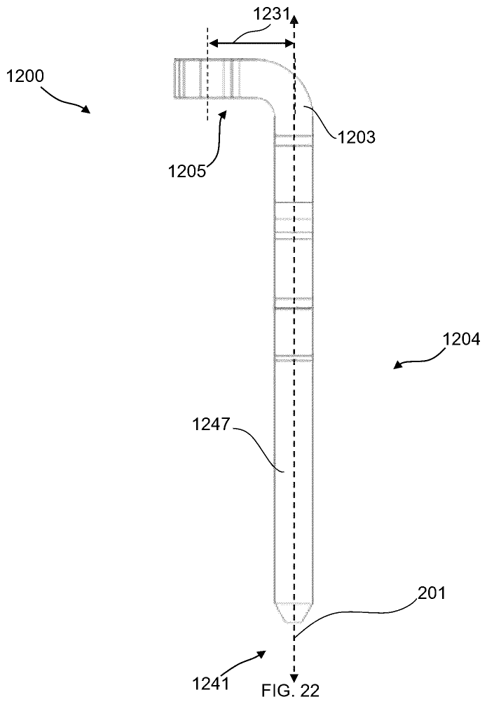

Although pins 100, 200 illustrated in FIGS. 1-17 can be configured for surface mounting, the pins disclosed herein may also include a lead 148, 248 for Through-Hole mounting, as shown in FIGS. 18-22. FIGS. 18-22 illustrate pins 1100, 1200 which are similar to the pins 100, 200 illustrated in FIGS. 1-15 but for being configured for Through-Hole mounting as discussed below. Accordingly, the part numbers applied to FIGS. 1-15 are similarly applied to FIGS. 18-22 but for incrementing each respective part number by 1000.

Through-Hole mounting involves inserting leads into through holes that are drilled into a printed circuit board and plated to conduct electricity. Additionally, solder is applied on opposite side of the through hole (e.g., the side of the board opposing the component connecting onto the board) to secure the pin into the through hole. Specifically, pins 1100, 1200 include leads 1148, 1248 extending downward from bases 1171, 1271 and configured to engage a through hole formed in a board.

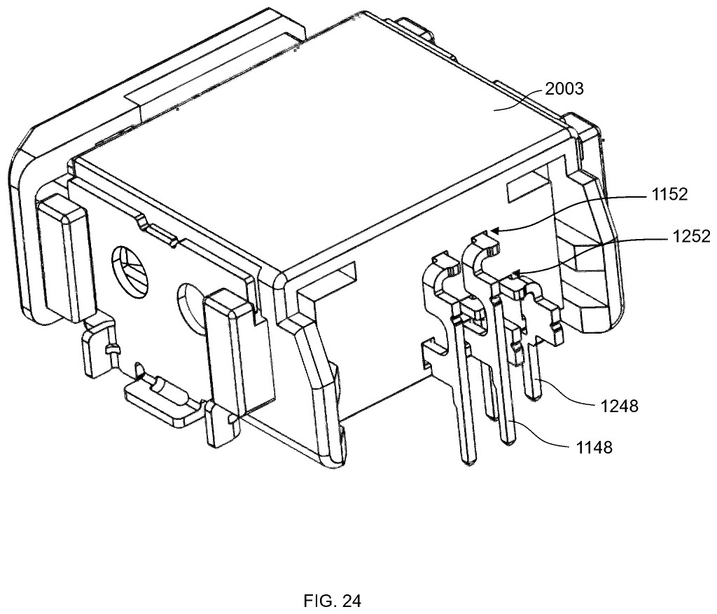

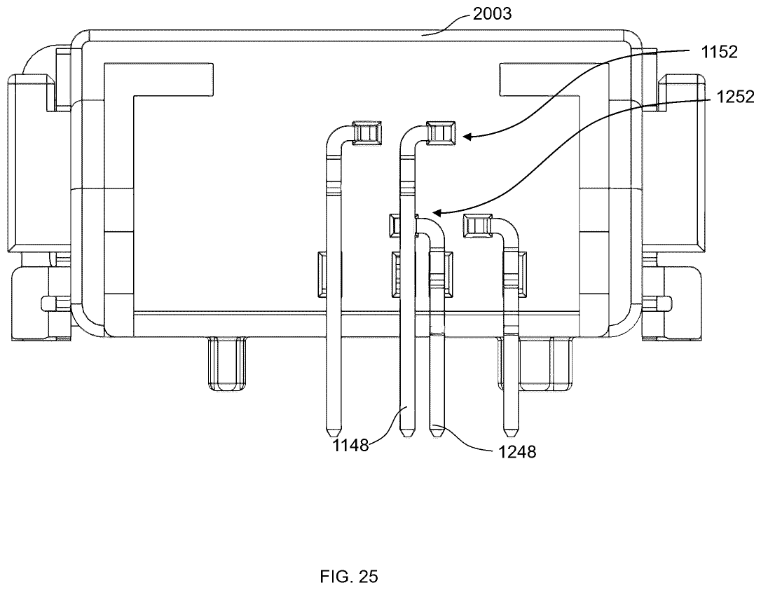

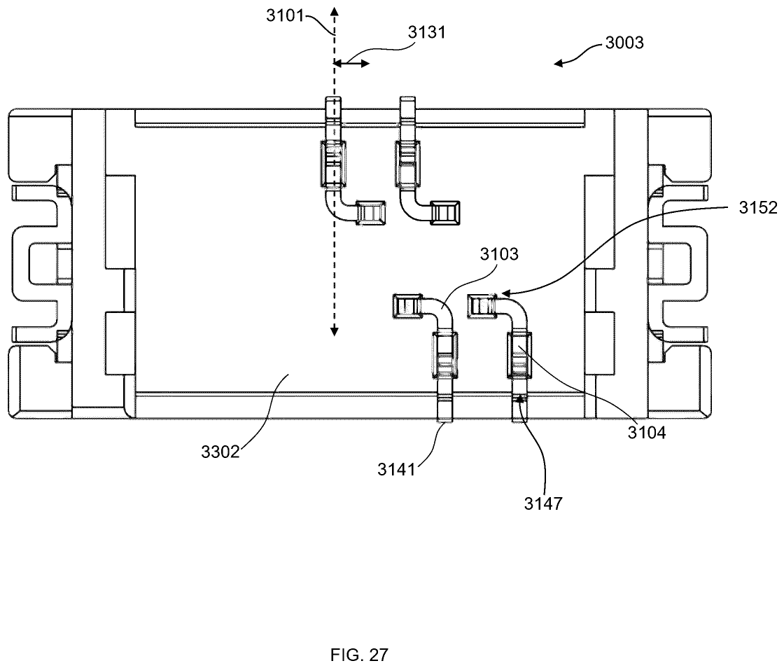

Additionally, in some aspects, the pins of the present disclosure are configured for top entry or side entry connectors. For example, turning to FIGS. 24-25, in some aspects, a male housing 2003 is configured to receive pins 1100 and 1200 so leads 1148 and 1248 contact a PCB below the connector and accordingly corresponding mating surfaces in an electrical system can engage mating surfaces 1152, 1252 along a plane parallel to the PCB. In other words, male housing 2003 is configured for side entry, like male housing 3, 1003 previously discussed. In other aspects, as shown in FIGS. 26-27, a male housing 3003 is configured for top entry, to receive pins 3100 so an outer surface 3147 of a leg 3104 can be soldered to PCB, as opposed to a base 3141 being soldered to a PCB. Accordingly, a corresponding mating surface engages a mating surface 3152 along a plane perpendicular to a PCB.

For a top entry configuration, as illustrated in FIGS. 26-27, pins 3100 have similar features to those described above, but the relative position of pins 3100 inside male housing 3003 has some differences from the relative position of pins 100, 200 in male housing 3. For example, like pins 100, 200, pins 3100 have a vertical axis 3101 extending generally orthogonally to base 3141 and through leg 3104. Because male housing 3003 and pins 3100 are configured for top entry, vertical axis 3101 extends between side walls 3304 of housing 3003, and generally parallel to top surface 3302 and bottom surface 3303 when pins 3100 are inside male housing 3003 via top surface 3302 of male housing 3003. As discussed, pin 100 has vertical axis 101 extending generally orthogonally to base 141 and through leg 104, so that when pin 100 is inside male housing 3, vertical axis 101 extends between top surface 302 and bottom surface 303 of male housing 3, and generally parallel to side walls 304.

Pins 3100 also comprise a longitudinal axis 3102 extending generally orthogonally to vertical axis 3101 and through contact 3105, so longitudinal axis 3102 extends generally through top surface 3302 and bottom surface 3303, and generally parallel to side walls 3304 of housing 3003 when pins 3100 are inside male housing 3003. As discussed above, pin 100 has longitudinal axis 102 extending generally parallel to top surface 302, bottom surface 303, and side walls 304 of housing 3 when pin 100 is inside male housing 3.

The differences between the orientation of vertical axis 3101 and longitudinal axis 3102 inside male housing 3003 and the orientation of vertical axis 101 and longitudinal axis 102 inside male housing 3 are a result of the orientation of male housing 3, 3003 to accommodate the space available and the installation environment. Pins 3100 provide the same advantages as disclosed for pins 100, 200, such as being able to enter a female housing without requiring subsequent processing, including bending or re-plating, after stamping.

For example, like pins 100, 200, pins 3100 include a transition portion 3103 extending between leg 3104 and contact 3105 that defines a side bend consistent with the orthogonal relationship between the vertical axis 3101 and longitudinal axis 3102. Accordingly, pin 3100 may include an offset 3131 between contact 3104, or longitudinal axis 3102, and leg 3104, or vertical axis 3101, where offset 3131 extends between vertical axis 3101 and longitudinal axis 3102 in a direction generally parallel with longitudinal axis 3102 and generally perpendicular to vertical axis 3101. By defining a side bend, transition portion 3103 flips contact 3105 relative to leg 3104 to align mating surface 3152 with a reciprocal mating surface, such as a spring in a female housing. As a result, pre-bent pin 3100 can enter a female housing without requiring subsequent processing, including bending or re-plating, after stamping.

Further, the pre-bent male pins disclosed herein can be configured for surface mounting or through-hole mounting in combination with a connector configured for rear entry or side entry. Rear entry and side entry connectors provide distinct connectivity within an electrical system depending on the space available on the board and the installation environment (e.g., automotive electrical housing).

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so first as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A pin assembly for a connector housing, comprising:
a first pin, comprising:
a first leg,
a first contact, and
a first transition portion engaging the first leg and the first contact; and
a second pin, comprising:
a second leg,
a second contact, and
a second transition portion engaging the second leg and the second contact,
wherein the first transition portion offsets the first contact from the first leg in a first direction and the second transition portion offsets the second contact from the second leg in second direction that opposes the first direction.

2. The pin assembly of claim 1, wherein the first pin and the second pin are pre-bent during a stamping process.

3. The pin assembly of claim 1, wherein the first pin further comprises a slot configured to receive the second contact.

4. The pin assembly of claim 1, wherein the first leg and the second leg are aligned at the same height, and the first contact extends higher than the second contact.

5. The pin assembly of claim 1, wherein the first contact comprises:
a mating surface configured to engage with the connector housing; and
a sheared surface orthogonal to the mating surface.

6. The pin assembly of claim 1, wherein the first contact partially overlays the second contact inside the connector housing.

7. The pin assembly of claim 1, wherein the first transition portion defines a first 90-degree side bend in the first direction and the second transition portion defines a second 90-degree side bend in the second direction.

8. The pin assembly of claim 1, wherein the first pin further comprises a first rib extending from an inner surface of the first leg and parallel to the first contact.

9. The pin assembly of claim 8, wherein the first rib partially defines the slot above the first rib and a port below the first rib.

10. The pin assembly of claim 8, wherein the first rib comprises a latch extending from an upper surface of the first rib.

11. The pin assembly of claim 1, wherein the first contact further comprises a latch having a sloped surface extending away from the first contact.

12. The male pin assembly of claim 11, wherein the latch extends from a sheared surface.

13. A pin assembly for a connector housing, comprising:
a first pin, comprising:
a leg, comprising:
an upper extension,
a lower extension,
a rib between the upper extension and lower extension, configured to engage a recess of the connector housing,
a slot defined between the upper extension and the rib, and
a port defined between the lower extension and the rib, configured to engage a of the connector housing,
a contact above the leg, and
a transition portion engaging the leg and the contact, such that the contact is rotated 90 degrees relative to the leg.

14. The pin assembly of claim 13, wherein the upper extension, the lower extension, and the rib all extend from an inner surface of the leg and parallel to the contact.

15. The pin assembly of claim 13, wherein the rib is formed of a material different from the remainder of the pin.

16. The pin assembly of claim 13, further comprising a second pin, wherein the slot is configured to receive the second pin.

17. The pin assembly of claim 13, further comprises a lead extending from the leg and configured to be inserted to a printed circuit board.

18. A connector assembly, comprising:
a connector housing; and
a pin assembly, comprising:
a first pin, comprising:
a first leg, and
a first contact having a first mating surface configured to engage with the connector housing and a first sheared surface orthogonal to the first mating surface, and
a second pin, comprising:
a second leg, and
a second contact having a second mating surface configured to engage with the connector housing and a second sheared surface orthogonal to the second mating surface,
wherein the first contact is laterally offset from the first leg towards a first direction and the second contact is laterally offset from the second leg towards second direction that opposes the first direction.

19. The connector assembly of claim 18, wherein the first contact and the second contact comprise latches configured to engage with the connector housing to stabilize the first pin and the second pin.

20. The connector assembly of claim 18, wherein the connector housing is top entry to receive the first pin and the second pin.
